(19) United States
(12) Patent Application Publication
(10) Pub. No.: US 2003/0078879 A1
(43) Pub. Date: Apr. 24, 2003

(54) System and method for managing debts

(75) Inventors: Takeshi Ieshima, Yokohama (JP); Seiji Futatsugi, Kawasaki (JP); Youji Shimizu, Yokohama (JP); Ken Chou, Yokohama (JP); Yoshitaka Nakata, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/080,163

(22) Filed: Feb. 19, 2002

(30) Foreign Application Priority Data
Oct. 23, 2001 (JP) 2001-324345

(51) Int. Cl. G06F 17/60

(52) U.S. Cl. 705/38

(57) ABSTRACT

There is provided a claim management system capable of enabling a customer utilizing a credit card settlement to determine a financial institution for settlement and a settlement method after the time of purchasing goods. When the customer selects deferred determination of a settlement financial institution and a settlement scheme in utilizing the credit settlement, the claim management system independent of individual financial institutions manages a claim vested in the customer. The claim management system periodically inquires the customer of the determination of a settlement financial institution and a settlement scheme and when the customer selects further deferment of the determination, requests the customer to pay interest.

### BACKGROUND OF THE INVENTION

The present invention relates to a settlement method in the field of credit settlement using a credit card.

A claim, that is, an obligatory right means “a right to receive money” and when a claim is vested in an individual, there is a typical example of settling accounts by using a credit card. In this instance, it suffices that a credit card be merely presented during purchase of goods on the grounds that deferred payment (in case of single time payment, payment on the last day of a purchase month, for instance) is promised by virtue of personal credit. At that time, a credit card firm has a claim on the purchase of goods that is vested in a personal purchaser.

In the past, when purchasing an article by utilizing the credit card settlement, a purchaser can select deferred payment depending on personal credit-worthiness (a credit amount, the amount of money that the purchaser can borrow).

In the conventional technique, the purchaser is permitted to select how many times the payment proceeds but is required to determine a method for the payment at the time of purchase. In addition, a payment date is set precedently to settle the rate of interest at the time of purchase. Accordingly, even if having a desire to change the payment method to another after the purchase based on the card, the purchaser is not permitted to do so. Thus, for example, when the purchaser is in trouble with cash flow and cannot make a payment on or before a due date, the purchaser is regarded as being delayed for payment and is sometimes obliged to pay predetermined overdue interest.

### SUMMARY OF THE INVENTION

An object of the present invention is to provide a payment method in which when making a card settlement by using a credit card for instance, a purchaser is permitted to select a payment method after purchase without determining any payment method at the time of the purchase.

To accomplish the above object, according to the present invention, when a goods purchaser determines deferred selection of a payment method, a claim vested in the purchaser at that time is transferred to a claim management system. Structurally, at the time that the purchaser then determines a payment method, the claim is transferred to a financial institution for which the payment method is settled.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the overall construction of a system and the processing flow.

FIG. 2 is a diagram showing the business affairs flow when a user purchases goods by presenting a card at a credit service alliance retail shop.

FIG. 3 is a diagram showing the business affairs flow when a user purchases goods by transmitting a credit card number in an electronic commerce site.

FIG. 4 is a diagram showing an example of data in a personal management table inside the system.

FIG. 5 is a diagram showing an example of data in a financial institution management table inside the system.

FIG. 6 is a diagram showing an example of data in a mortgage receipt details table inside the system.

FIG. 7 is a diagram showing an example of data in a mortgage management table inside the system.

FIG. 8 is a diagram showing an example of a screen for asking for selection as to whether determination of a payment means is deferred at the time of purchase.

FIG. 9 is a diagram showing an example of data in a use details table inside the system.

FIG. 10 is a diagram showing an example of data in a claim management table inside the system.

FIG. 11 is a diagram showing an example of an alarm message transmitted to an individual when a total or an aggregate value of current price of a claim vested in the individual exceeds a total of unsecured credit appraisal value and mortgage current appraisal value.

FIG. 12 is a diagram showing an example of a payment means selection request message transmitted on a deadline from the management system to the individual.

FIG. 13 is a diagram showing an example of a settlement transaction details table inside the system.

### DETAILED DESCRIOPTION OF THE EMBODIMENTS

Embodiments of the invention will now be described with reference to the accompanying drawings.

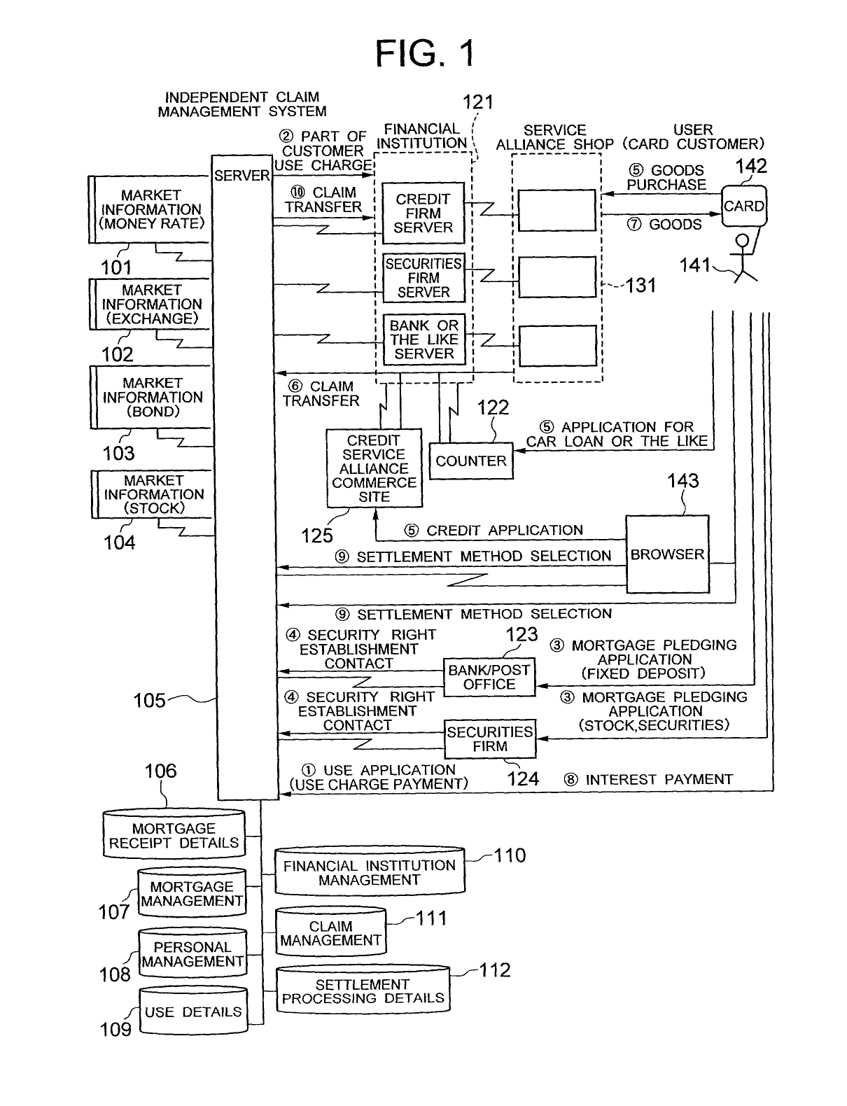

FIG. 1 is a diagram showing the overall construction of the invention and the processing flow (outline). Involved in the present invention are a personal user 141, an independent claim management system 105 for managing claims for a user, a financial institution 121 for providing a credit service with the user, a credit service alliance shop 131 for mediating services in commerce and a credit service alliance electronic commerce site 125.

The independent claim management system 105 acquires any time market condition data of market information (money rate) 101, market information (exchange) 102, market information (bond) 103 and market information (stock) 104. Also, the system 105 manages the management of claims for and mortgages presented by an individual by using a mortgage receipt details table 106 mortgage management table 107, use details table 109 and claim management table 111. The individual can place mortgages in the independent claim management system 105 through the medium of an account opened with a bank/post office 123 or a securities firm 124. For example, when the individual purchases goods by presenting a credit card 142 to the credit service alliance shop 131 or by transmitting a credit card number to the electronic commerce site or when the individual applies for a car loan, for which any financial institution is undetermined, at a counter 122 of a financial institution, a signal arrives at the independent claim management system 105 through a server of the financial institution 121 and if credit of the user is acknowledged, the management of a claim is started.

The user continues payment of interest on the claim until the user selects a settlement financial institution and a settlement means that are profitable to the user and informs the system of them through, for example, a browser 143, and the independent claim management system 105 proceeds with the management of the claim for which any settlement means is undetermined.

Specifically, the above processing will be executed as follows.

(1) The user 141 applies for a use of the independent claim management system 105 and begins payment of a charge for use.

(2) Part of the use charge paid by the user 141 becomes an income to the financial institution 121.

(3) The user 141 is permitted to place a mortgage in the independent claim management system 105 through, for example, an account of a bank when the use owes a debt or obligatory duty.

(4) When the mortgage is placed, the independent claim management system 105 receives a notice to the effect that a security right is pledged, for example, from the bank.

The procedure up to now completes preparation for use. The procedure for goods purchase and ensuing processing will be described hereinafter.

(5) The user 141 purchases goods at the credit service alliance shop 131 or applies for a credit/card loan by way of a bank, for example.

(6) When the user 141 makes an expression that determination of a settlement financial institution and a settlement means is deferred in the above (5), a claim on that settlement is transferred from the financial institution 121 such as credit firm or bank to the independent claim management system 105.

(7) When the independent claim management system 105 makes a reply purporting that it acknowledges credit of the user and takes charge of the claim, the management of the claim by the independent claim management system 105 is started and the user 141 is permitted to receive goods.

(8) The user 141 pays interest in the form of monthly or annual interest to the independent claim management system 105 over a period through which the claim is managed.

(9) The user 141 informs the independent claim management system 105 of determination of a settlement financial institution and a settlement means through a network or by mail, for instance. Involved in the settlement method are a financial institution, a term of payment and a currency of settlement.

(10) The claim is transferred from the independent claim management system 105 to the financial institution 121 selected by the user 141 to make a settlement (or to settle accounts).

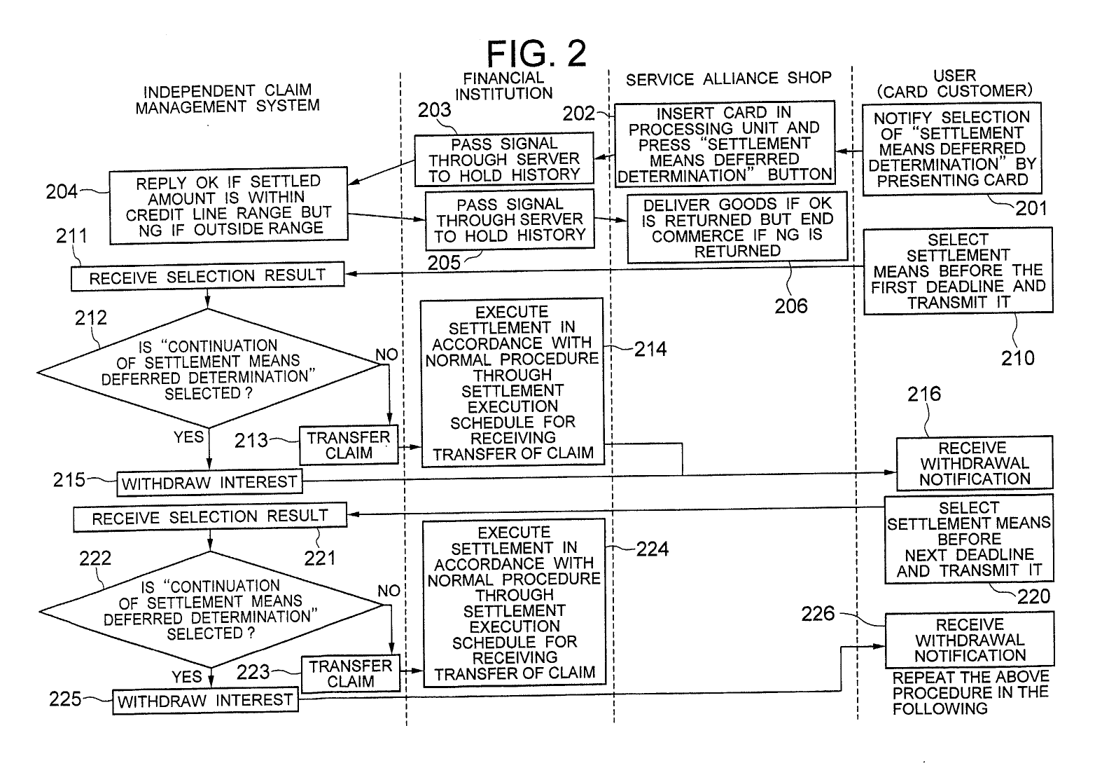

FIG. 2 is a diagram showing the processing flow when the user purchases goods at a credit service alliance retail shop by presenting a card. Firstly, the user 141 presents the card 142 and makes such selection during the goods purchase that accounts are not settled by an institution issuing the card but the determination of a settlement financial institution and a settlement means is deferred (201). Then, a person in charge in the retail shop (service alliance shop) inserts the card into a card processing unit, inputs an amount of money and inputs deferred determination of a settlement means instead of normal settlement by means of a button (202). This causes a signal to pass through the card issue institution (203) so as to reach the independent claim management system 105. The independent claim management system 105 decides credit of the user (204) and if purchase of goods by the user is acknowledged as a result of the credit, the system 105 informs the service alliance shop of a reply to this effect via the financial institution (205), thereby enabling the user to receive an article (206).

The independent claim management system 105 manages claims in accordance with a monthly deadline, for instance, and the user informs the system of the first determination of a settlement institution/means before the first deadline is over (210). Then, the independent claim management system 105 decides whether the user selects continuation of the deferred determination of settlement means (212). If the continuation is not selected (213), the independent claim management system 105 transmits information indicative of automatic withdrawal of the claim to a selected financial institution and the selected financial institution executes a settlement by means of a settlement means selected by the user (214). In case the continuation of the deferred determination of settlement means is selected, interest covering the period in question is paid to the independent claim management system (215). Thereafter, the user selects similar decision making before the next deadline (220), followed by a flow similar to that for the preceding deadline (221 to 226).

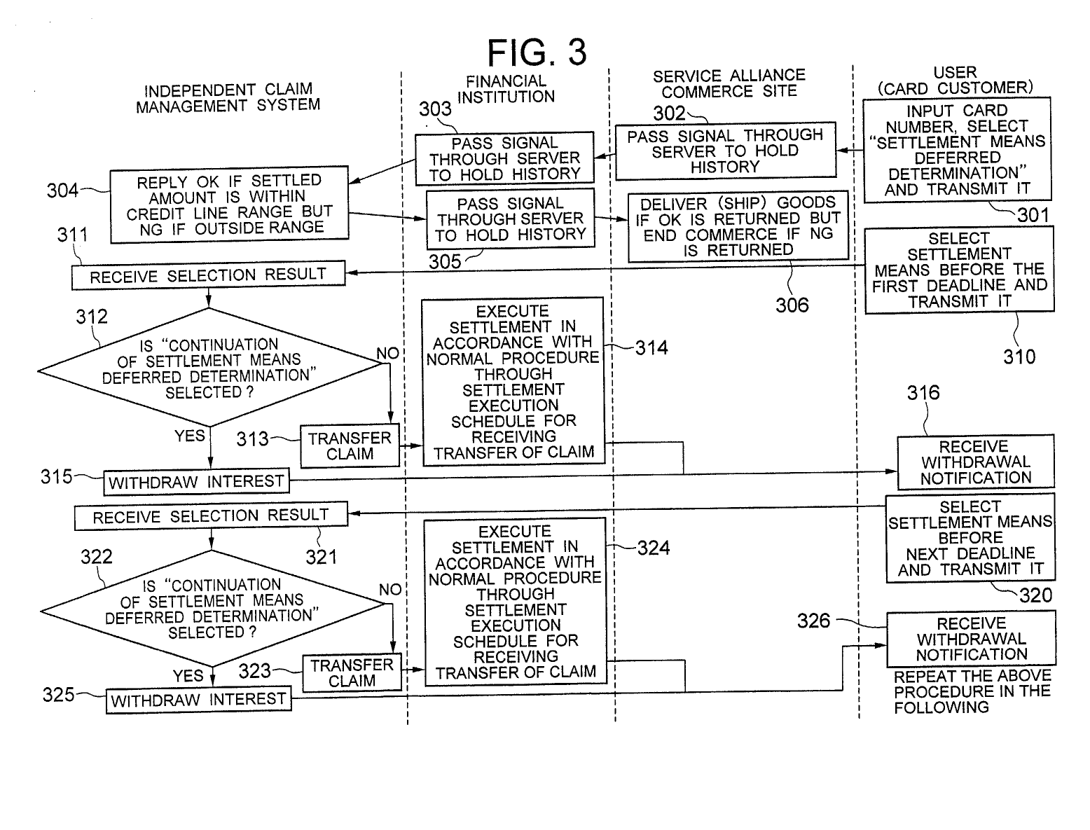

FIG. 3 is a diagram showing the business affairs flow when a user purchases goods by transmitting a credit card number in an electronic commerce site. The user 141 transmits to the site 125 the card number together with a message to the effect that the user desires deferred determination of a settlement means (301). That information passes by the commerce site (302) and passes through a card issue financial institution (303) so that the independent claim management system 105 may decide credit (304) and a result of decision may arrive at the commerce site via the card issue financial institution (305), thus causing goods to be shipped (306). The ensuing processing is quite the same as that in the case of the processing carried out via the retail shop shown in FIG. 2 (310 to 326).

A gross framework of the system construction and business affairs flow has been set forth hereinbefore. The embodiment will now be described specifically hereunder by indicating data possessed by the independent claim management system 105 and information transmitted thereby.

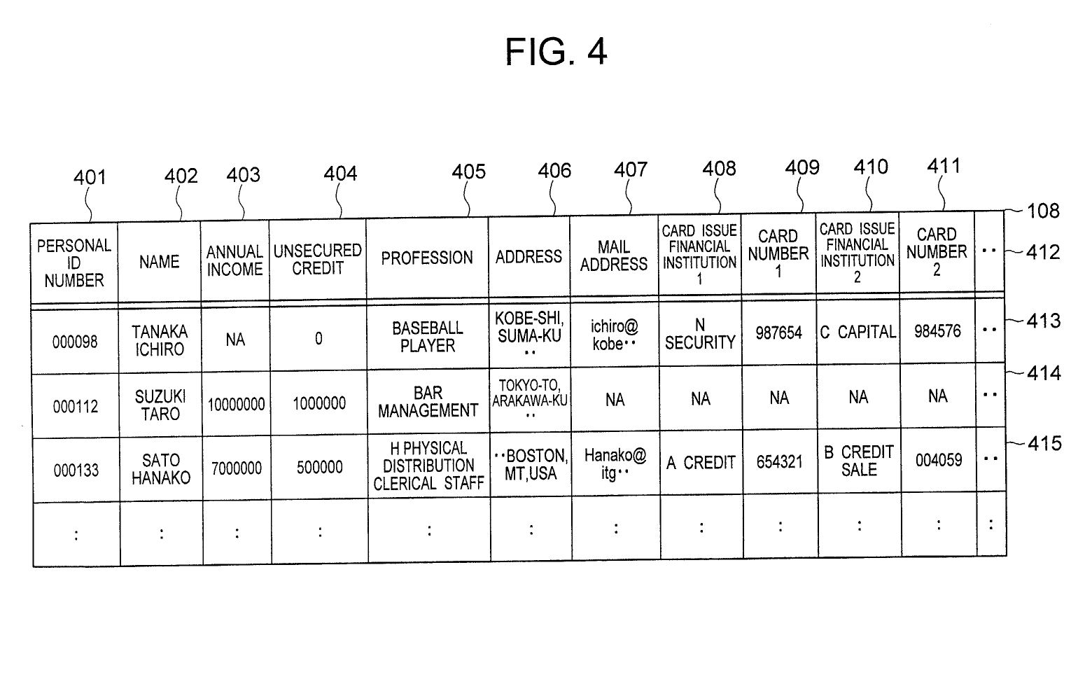

FIG. 4 shows an example of data in a personal management table inside the independent claim management system 105. Information about an individual who applies for use of this system and is acknowledged is held in this table. The personal information managed by this table includes personal identification number 401, name 402, annual income 403, unsecured credit amount 404 and possessed card 408. Here, there are indicated three records in total. When taking a record 413, for instance, it will be seen that an individual managed by a personal identification number 000098 is named TANAKA ICHIRO, his annual income is not managed, indicating that the unsecured credit amount is zero, his profession is a baseball player and he possesses cards of N security and C capital. Similarly, it will be seen from a record 414 that an individual named SUZUKI TARO is managed by a personal identification number 000112, his annual income is 10,000,000 yen, his unsecured credit is 1,000,000 yen and he manages a bar but possesses no mail address and credit card. It will also be seen that an individual named SATO HANAKO is managed by a personal identification number 000133, her annual income is 7,000,000 yen, her unsecured credit is 500,000 yen and she lives in USA.

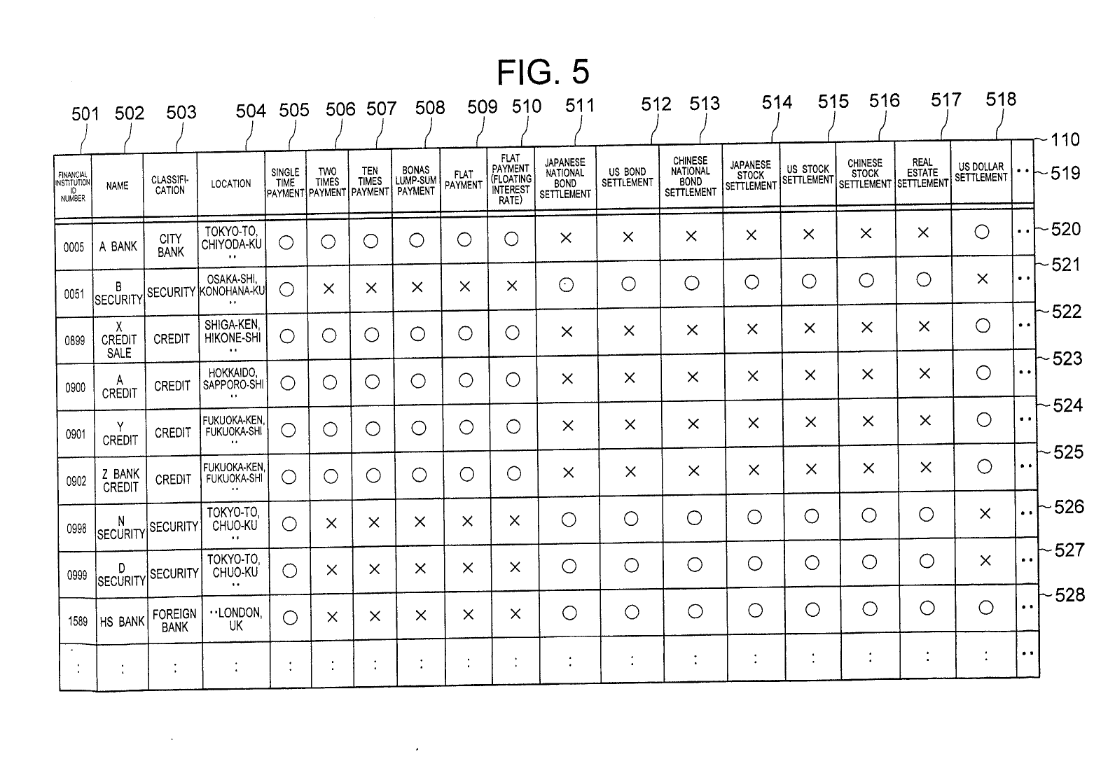

FIG. 5 shows an example of data in a financial institution management table inside the independent claim management system 105. When selecting a settlement financial institution, a personal user can select a financial institution in the range managed by this table. Information concerning financial institutions managed by this table includes name 502, classification 503 and location 504 of financial institution and selectable settlement methods 505 to 510. Here, there are indicated nine records in total. It can be read from a record 520 that an institution managed by a financial institution identification number 0005 is A bank, the bank is located at Chiyoda-ku, Tokyo-to and as a selectable settlement means, single time or two times payment, flat payment (the way of payment in which payer pays predetermined amount of money in every predetermined period) or dollar settlement is permitted but a settlement by security or real estate is not permitted.

Similarly, it will be seen from a record 521 that an identification number 0051 is for B security of a securities firm located at Konohana-ku, Osaka-shi, single time payment is permitted but two times payment or a bonus lump-sum payment is not selectable and a settlement by national bonds, stocks or real estate is selectable. Further, it is indicated that an identification number 0899 is for X credit sale of a credit firm located in Hikone-shi, Shiga-ken and like A bank, a security settlement is not selectable but single time payment or flat payment is selectable.

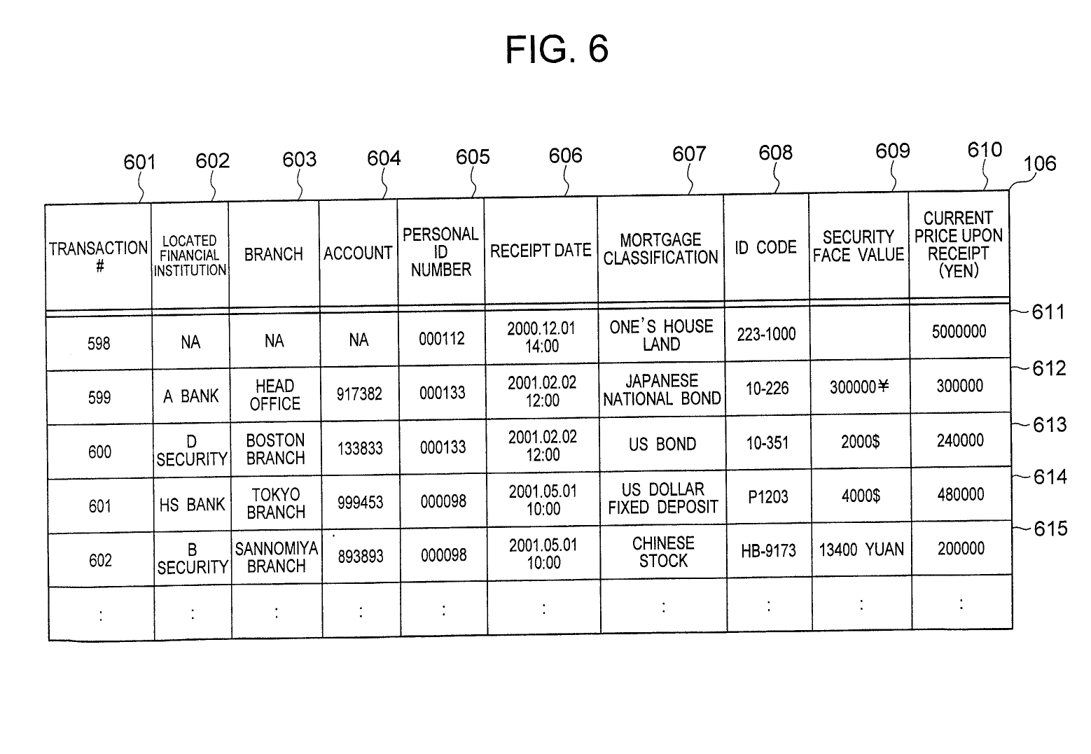

FIG. 6 shows an example of data in the mortgage receipt details table inside the system. As described previously, credit pledged by the independent claim management system 105 to a personal user is addition of unsecured amount outstanding (calculated from annual income and occupation) and amount outstanding based on mortgage. Accordingly, a user desiring a high-sum claim to be managed or a user desiring an annual income not to be managed is urged to place a mortgage in the system before purchase and the placed mortgage is recorded on this table.

For example, it will be seen that a record 611 indicated by a transaction number 598 in this table is a record of a mortgage placed by 000112 (SUZUKI TARO), the mortgage being based on his house land and classified into an internal identification code 223-1000, and a current price in yen at the time of receipt is 5,000,000 yen. Gathering from the fact that the mortgage is not located at a specified financial institution, it will be read that the mortgage is placed by taking a procedure directly applied to the independent claim management system 105. Similarly, it will be seen that 000133 (SATO HANAKO) placed a Japan national bond (located in an account of A bank) and a US bond (located in an account of D security) at noon on Feb. 2, 2001 that were at worth current prices of 300,000 and 240,000 in yen, respectively. Similarly, it will be read that 000098 (TANAKA ICHIRO) placed, at ten on May 1, 2001, a US dollar fixed deposit being deposited in HS bank and a Chinese stock being in the custody of B security that were at worth current prices of 480,000 and 200,000 in yen, respectively.

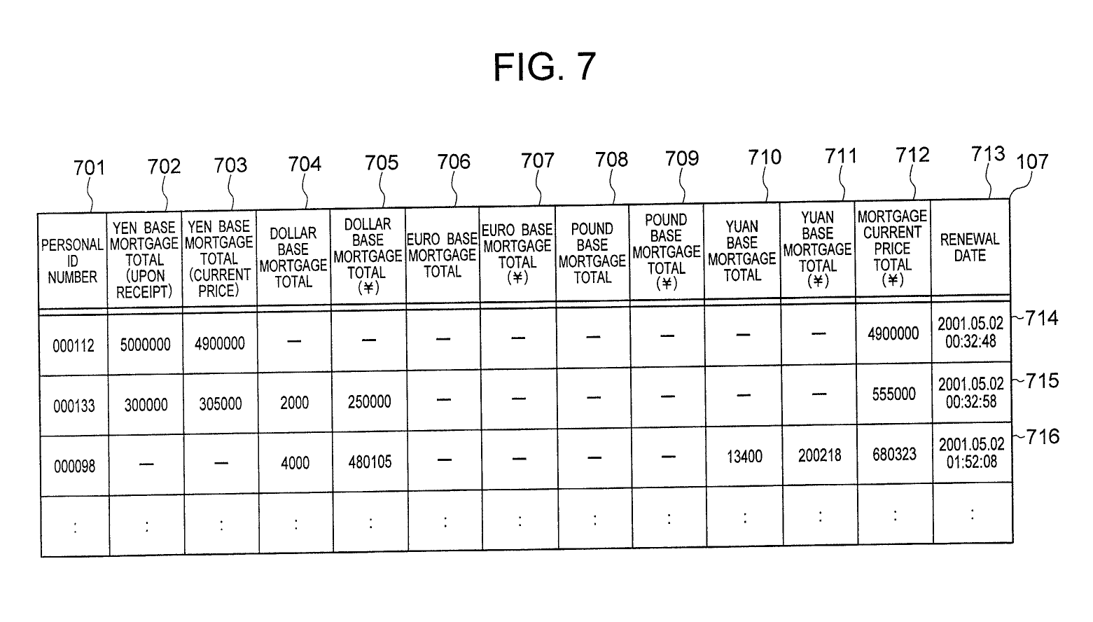

FIG. 7 shows an example of data in a mortgage management table inside the system. Since mortgages are used for credit calculation, the placed mortgages are individually managed at current prices. It will be read that the data example is as of May 2, 2001 as indicated by a renewal date field and current aggregate values in yen of mortgages at that time were 4,900,000 yen for 000112 (a decrease in value of 100,000 yen over about five months), 555,000 yen for 000133 (an increase in value of 15,000 yen over about three months) and 680,323 yen for 000098 (an increase in value of 323 yen over about 15 hours).

In this manner, the personal user can be credited by the claim management system in accordance with the annual income or placed mortgage and when purchasing goods under the condition that credit is pledged, the user can move the claim to place it in management by the management system without determining any settlement financial institution and settlement means.

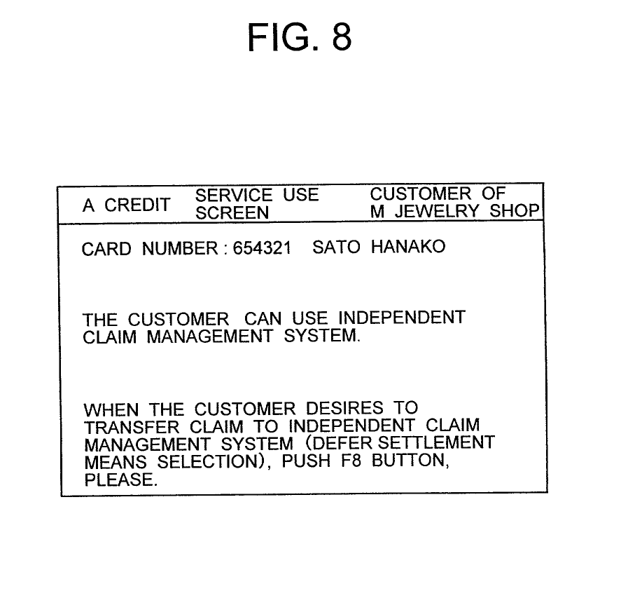

FIG. 8 shows an example of a screen for asking an individual to make a choice, at the time of purchase, as to whether determination of a settlement means is deferred. The screen exemplified herein is one displayed on a card processing unit when M jewelry shop is an A credit service alliance retail shop and a user named SATO HANAKO possessing an A credit card (of a number 654321) is about to buy goods by presenting the card. An indication that the user can utilize the management system is displayed on the screen, demonstrating that a record of the user is present in the personal management table of FIG. 4 and this fact is notified to a server on the financial institution (A credit) side. A retail shop can know that the user can select deferred determination of a settlement institution and a settlement means by watching this screen. Depending on either the fact that the user desires settlement by the A credit or the fact that the user desires transfer of the claim to the claim management system, that is, deferred determination of settlement institution/means, the retail shop transmits a result of decision to the A credit. Through this, the desire of the user is once forwarded to the credit firm together with a purchase money amount.

When the normal credit settlement is desired, the pledged credit is checked by the A credit and if acceptable, an article is delivered to the user (the claim is placed in management by the A credit). On the other hand, when the deferred determination of a settlement means is desired, a signal is sent to the claim management system via the A credit (a history is acquired) and the pledged credit is checked. If acceptable, the claim is placed in management by the system and an article is delivered to the user.

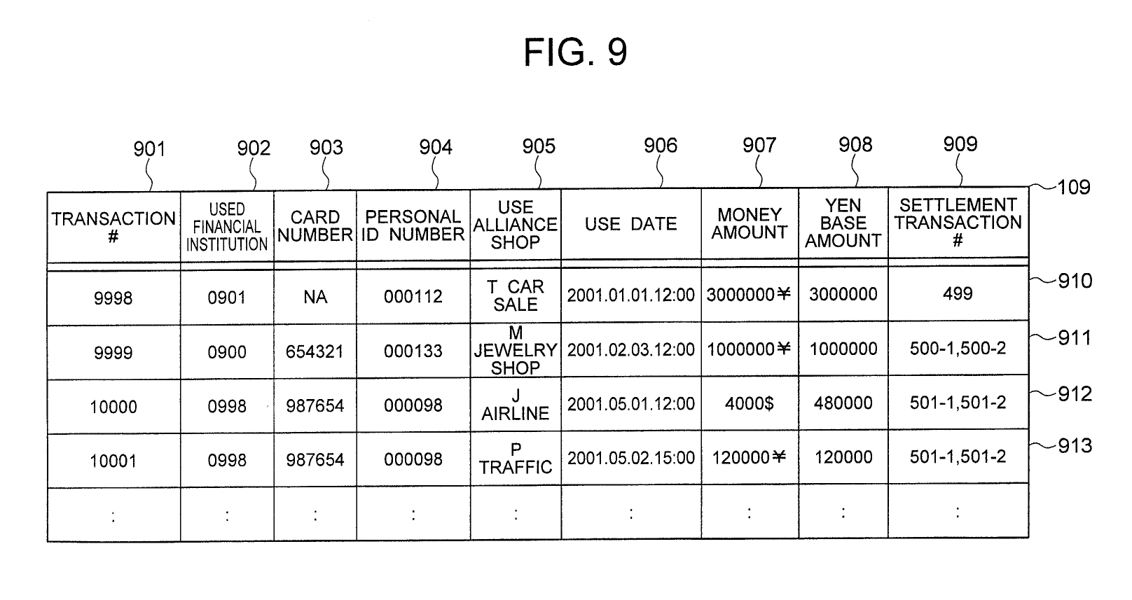

FIG. 9 shows an example of data in a use detail table inside the system. Underwriting of a personal claim by the management system is recorded on this table. It is indicated that in transaction number 9998, the user (SUZUKI TARO) of identification number 000112 bought an article at a price of 3,000,000 yen at noon on Jan. 1, 2001 at T car sale and the claim was transferred to the management system. Also, the user applied for a loan of a financial institution number 0901 (Y credit) to select deferred determination of settlement, demonstrating that the user was not a card member of Y credit at the time of the purchase. Accordingly, the card number is not recorded on the record. Settlement transaction number 909 is a completion number assigned when the settlement financial institution and settlement means are determined for the claim and transfer of the claim to the financial institution is finished. During setting of the record, that is, immediately after the purchase, NULL setting prevails. In connection with the present record, it will be seen that a number 499 is assigned and the transfer is ended. For records to be describer hereinafter, the state after transfer ends similarly will be described.

Transaction number 9999 indicates that as shown in FIG. 8, the user SATO HANAKO possessing the card (of a number 654321) bought an article at a price of 1,000,000 yen at M jewelry shop with the claim placed in management by the system but transfer of the claim to the financial institution is completed by totaling completion numbers 500-1 and 500-2.

Transaction numbers 10000 and 10001 indicate that the user TANAKA ICHIRO possessing the card (a number 987654) of N security bought goods at a price of 480,000 yen (4000 US dollars) and goods at a price of 120,000 yen on first and second days of May, 2001 at J airline and P traffic, respectively, and the claims were transferred to the management system. Both the claims are assigned with settlement transaction numbers 501-1 and 501-2, demonstrating that the two claims are dealt with at a time by totaling the two settlements.

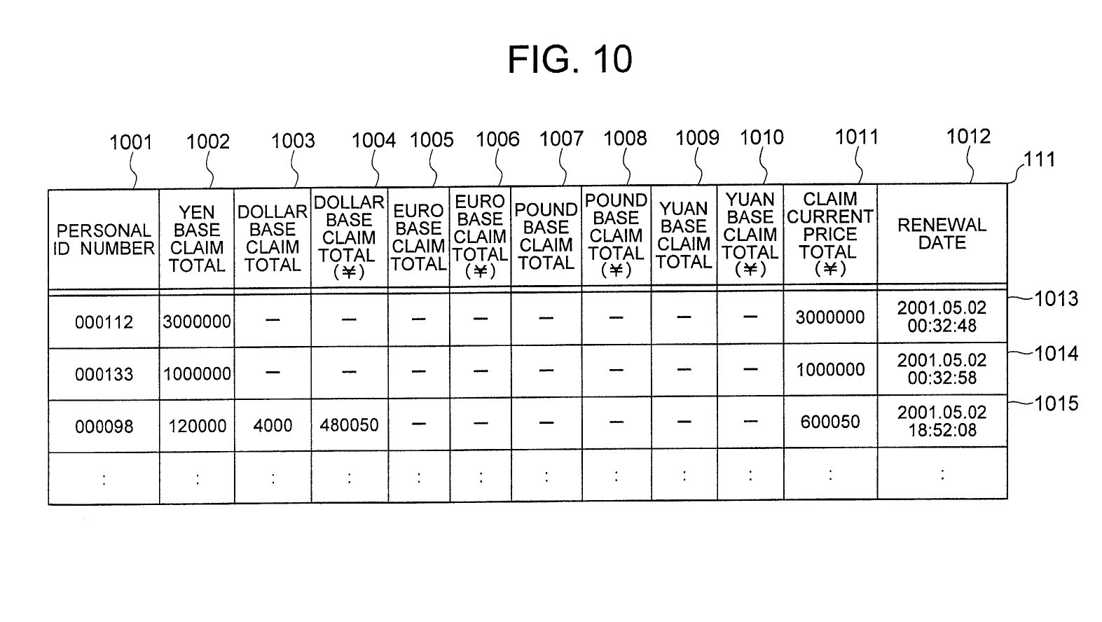

FIG. 10 shows an example of data in a claim management table inside the system. Like mortgage, claims are checked for current appraisal value any time to check each individual for a difference between the current appraisal value and (unsecured credit+secured current appraisal value). Here, data as of May 2, 2001 is indicated and it will be read that claims vested in 000112 and 000133 do not undergo price movements from the time of transfer but a claim vested in 000098 is partly based on US dollar and when exchanged to yen, gets an increased value of 50 yen over about four hours.

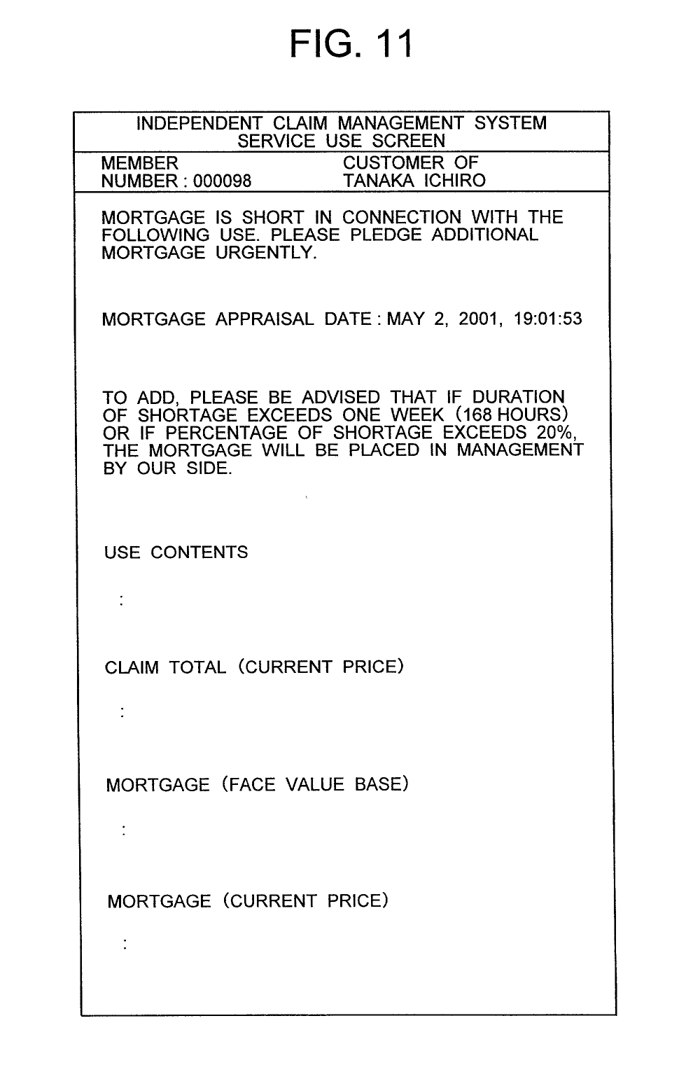

FIG. 11 shows an example of a screen of an alarm message transmitted to an individual having a claim on a mortgage when an aggregate value of current price of the claim exceeds (unsecured credit+secured current appraisal value). It is notified through a network or by mail that if a state that an additional mortgage is not placed continues, then the mortgage will be placed in management by the system.

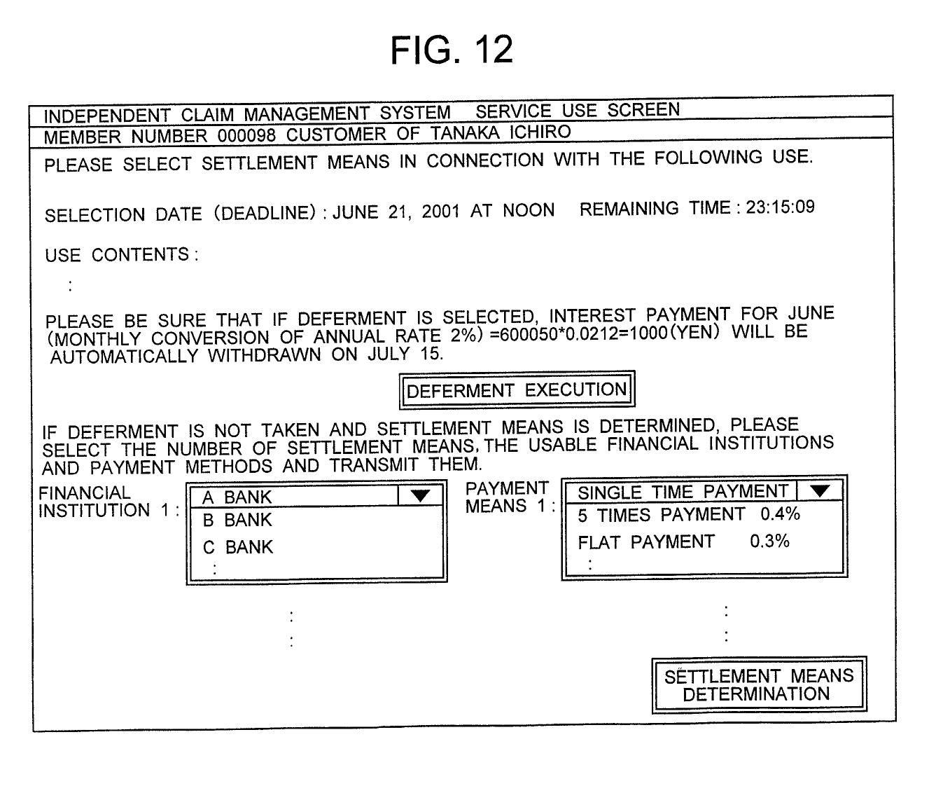

FIG. 12 shows an example of a settlement means selection request message transmitted from the management system to an individual on a monthly deadline, for instance. As described previously, when the selection of a settlement institution and a settlement means is further deferred on the deadline, the management system receives interest over a period up to that deadline (from the purchase time point or the previous deadline). In case the deferment is not selected to move to settlement, a financial institution and a payment means selectable by the financial institution are selected on the basis of the financial institution management table of FIG. 5 and are transmitted, so that the claim is transferred from the management system to the financial institution.

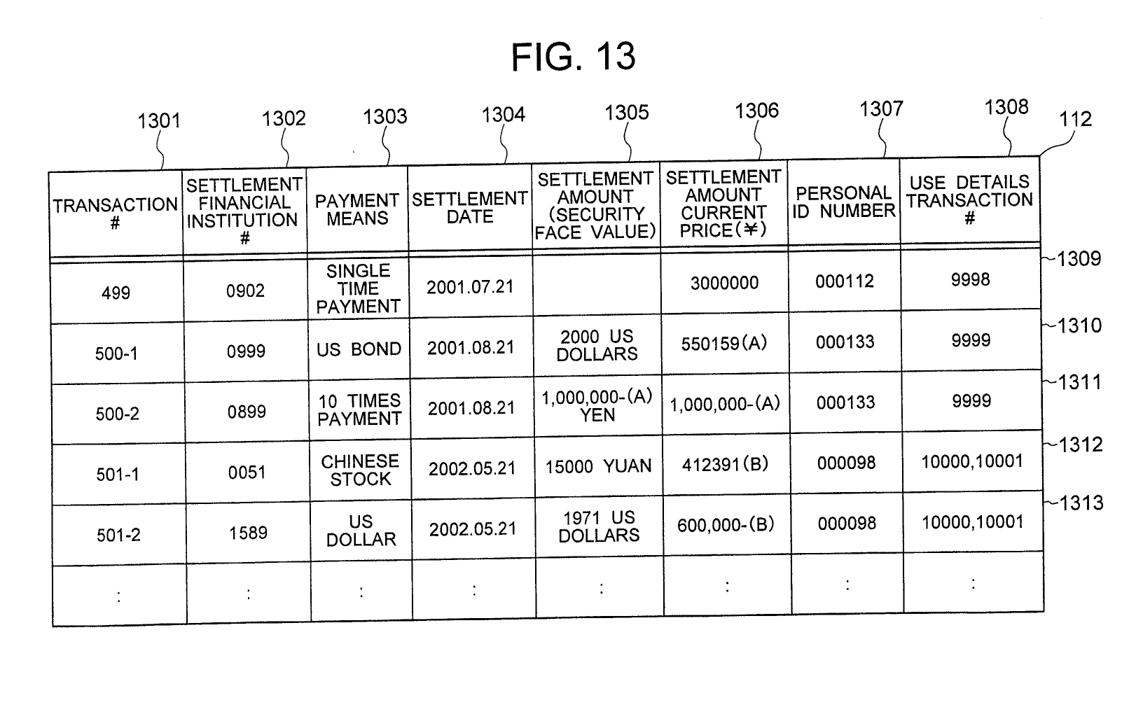

FIG. 13 shows an example of data in a settlement details table inside the system. When the claim is eventually transferred to the financial institution and the processing inside the system is completed, the contents or substance of the claim is recorded on this table. Transaction number field 1301 and use details transaction number field 1308 are synchronized with the settlement transaction number field 909 and transaction number field 901 in the use details table of FIG. 9 so as to be referenced to each other. For example, a transaction number 499 indicates that the user (SUZUKI TARO) of personal identification number 000112 settled a single time payment of financial institution number 0902 (Z bank credit) at an aggregate price of 3,000,000 yen for a claim on a use details transaction number 9998. Similarly, transaction numbers 500-1 and 500-2 indicate that the user (SATO HANAKO) of identification number 000112 settled payment for a claim (1,000,000) on a use details transaction number 9999 by a US bond being in custody of a financial institution number 0999 (D security) for about 550,000 yen and by ten times payment of a financial institution number 0899 (X credit sale) for the remainder. In the drawing, (A) is a symbol for explanation to indicate that in settlement current appraised value (¥) field of a record of transaction number 500-2, a money amount of 449841 obtained by subtracting (A), that is, 550159 from 1,000,000 is set and in settlement amount (securities face value) field, a value of US dollars corresponding to this money amount is set. This holds true for records 501-1 and 501-2 to be described below. In the records 501-1 and 501-2, it is indicated that the user (TANAKA ICHIRO) of identification number 000098 settled payment for claims on use details transaction numbers 10000 and 10001 (600,000 in yen at that time) by a Chinese stock being in custody of a financial institution number 0051 (B securities) for about 410,000 yen and by US dollar payment of a financial institution number 1589 (HS bank) for the remainder.

According to the present embodiment, an individual letting the independent claim management system possess a claim can move the claim freely. In the embodiment, the payment for the claim is exemplified by such variations as payment in yen, foreign currency, securities, installments or LIBOR, thus leaving it to the individual to decide what condition is the most profitable to the individual when moving the claim. As will be seen from FIG. 1, various kinds of information about market conditions (101 to 104) presented to the personal claim management system are presented to the individual and the individual can decide how the claim is to be moved by watching the presented information.

Further, as an expansion of the present service, the function of enabling the individual to estimate values of market conditions at a future time point and calculate the outstanding value or risk value in accordance with various forms of claim can be attached to the present system. The calculation function is effective as measures for improving service in the present embodiment.

Furthermore, the financial institution for dealing with credit service can handle part of a charge for use paid by the customer to the independent claim management system as new income source.

When issuing a credit card capable of using this system by a contract with a user using this system, the financial institution incorporated in the present system causes the user to select “whether the use utilizes the present system” and if the user selects utilization, causes the user to pay a membership fee or charge higher than usual, thereby discriminating this case from the case of nonuse.

According to the foregoing embodiment, the individual can select a settlement means of a financial institution that is the most profitable to the user any time without resort to the purchase time and the financial institution can assure a new income source. The independent claim management system can ask the individual to pay, together with a use charge income, interest over a period during which the management of the claim is kept to be entrusted, that is, during which the individual keeps the settlement method undetermined.

In the present invention, the personal claim is transferred from the financial institution to the management system at a timing that an article is purchase a retail shop (by using a credit card) but in addition to the above, the personal claim may be transferred when a car loan is applied for at a counter of a bank or when a credit settlement is applied for via the financial institution in electronic commerce. The procedure for the individual to select the settlement financial institution and settlement method and cause the claim to be transferred from the management system to the financial institution can be applied for to the management system by a written document or by an electronic application via a network.

As the selectable settlement means, there are available, in addition to single time payment or revolving payment used in the general credit settlement or revolving payment, settlements based on foreign currency and securities and a settlement based on real estate. As the mortgage placed in the system by the individual for the purpose of guaranteeing the debt, foreign currency, securities or real estate may be available.

According to the present invention, a personal customer utilizing credit service can purchase goods without making a decision as to what financial institution and what method are employed to settle a claim vested in the customer and can flexibly determine a settlement means by considering income and market conditions.

It should be further understood by those skilled in the art that the foregoing description has been made on embodiments of the invention and that various changes and modifications may be made in the invention without departing from the spirit of the invention and scope of the appended claims.

What is claimed is:

1. A credit settlement method in purchasing goods by utilizing a credit card, comprising the steps of:
pledging a mortgage precedently in using said credit card;
when the mortgage is pledged, giving a notification to this effect to a financial institution handling a credit settlement; and
when purchasing an article by utilizing a credit card of the financial institution receiving said notification, selecting whether a settlement method for said article is determined at the time of purchase or the determination is deferred.

2. A credit settlement method according to claim 1, wherein when deferred determination of the settlement method for said article is selected, a claim incurred by the selection is transferred to a claim management system.

3. A credit settlement method according to claim 2, wherein when deferred determination of the settlement method for said article is selected and after the selection, a settlement method is actually determined, said claim is transferred to a financial institution for making a settlement in accordance with the determined settlement method.

4. A credit settlement method in purchasing goods by utilizing a credit card, comprising the steps of:
selecting whether a settlement method utilizing the credit card is carried out only at the time of purchase of goods or is deferred for determination when a contract of the credit card is made; and
making a difference in a predetermined charge concerning said contracted credit for the case of determination at the time of purchase and the case of deferred determination.

5. A claim management system in settlement utilizing a credit card, comprising:
means for managing personal information concerning a user utilizing a credit card;
means for managing information concerning a mortgage of the user utilizing said credit card;
means for managing information concerning a financial institution for making a settlement based on said credit card; and
means for managing, when said credit card is used by the user utilizing said credit card and it is selected to determine the settlement based on said credit card after the time of purchase, a claim incurred by the selection.

6. A claim management system according to claim 5, wherein said claim is transferred from said financial institution to said claim management system.

7. A claim management system according to claim 5, wherein when it is selected to determine the settlement based on said credit card after the time of purchase, a notification purporting that a settlement method is to be determined periodically is given to the user making said selection.

8. A claim management system according to claim 7, wherein when said notification is not replied, said claim management system withdraws interest on said claim from an account of the user making said selection.

9. A claim management system according to claim 7, wherein when it is selected to determine the settlement based on said credit card after the time of purchase, a mortgage of the user utilizing said credit card is monitored on the basis of market conditions and in the case of a shortage of the mortgage, an alarm to the effect that an additional mortgage is to be pledged is raised.

10. A claim management system according to claim 7, wherein said claim management system is independent of the financial institution for making a settlement based on said credit card.
